(19) United States
(12) Patent Application Publication
(10) Pub. No.: US 2009/0271238 A1
(43) Pub. Date: Oct. 29, 2009

(54) SYSTEM AND METHOD OF MANAGING A WORKFLOW WITHIN AND BETWEEN A CRIMINAL CASE MANAGEMENT SIDE AND A CRIMINAL INTELLIGENCE MANAGEMENT SIDE IN THE JUSTICE AND PUBLIC SAFETY DOMAIN

(75) Inventors: Michael Thomas Himley, Laguna Niguel, CA (US); Mamta Dilip Patel, Corona, CA (US)

Correspondence Address: Michael D. Himley;Eagle Intelligence LLC, Suite G-152, 27881 La Paz Road, Laguna Niguel, CA, 92677, US

(73) Assignee: Eagle Intelligence LLC, Laguna Niguel (US)

(21) Appl. No.: 12/098,408

(22) Filed: Apr. 4, 2008

(51) Int. Cl. G06Q 50/00; G06Q 10/00

(52) U.S. Cl. 705/8

(57) ABSTRACT

A method for managing a workflow within and between a criminal case management side and a criminal intelligence management side in a justice and public safety domain that includes tracking workbook sharing across organizations. Each workbook contains a unique reference number. The history files in each workbook displays where it was disseminated from, and when; or who it was imported from, and when. The legal and security level remains attached to the electronic workbook. Its history follows it through its life span.

### CROSS-REFERENCE TO RELATED APPLICATION

This application relies for priority upon U.S. Provisional Application No. 60/921,434 filed on Apr. 4, 2007, the contents of which are herein incorporated by reference in their entirety.

### TECHNICAL FIELD

The following disclosure relates to a system and a method for managing a workflow within and between a criminal case management side and a criminal intelligence management side in a justice and public safety domain.

### BACKGROUND

Conventional criminal/terrorist intelligence systems operate within a data warehouse environment or within a network-linked group of warehouse nodes. The conventional systems typically operate in environments that are network based. In these systems, authorized users input criminal intelligence information into a data warehouse where it is maintained according to federal guidelines. The data warehouse may be replicated to other regional nodes within the network. The nodes act as data repositories and provide search and some analysis tools to registered users. Each user of the conventional systems has a unique login and password, and once connected to a virtual private network, are given privileges to search the information contained in the database.

### BRIEF DESCRIPTION OF THE DRAWINGS

FIG. 1 is a diagram of one example of a network and network devices including a user access point and a network based criminal and intelligence information management system;

FIG. 2 is a diagram of one example of a general computing device that may operate in accordance with the claims;

FIG. 3 illustrates a flow diagram of an exemplary modular intelligence-led policing process.

FIG. 4 illustrates an exemplary architectural diagram of the management system;

FIG. 5 illustrates a flow diagram of an exemplary Data Collection Process;

FIGS. 6-9 are exemplary screen shots of an exemplary aspects of the information management system;

FIG. 10 illustrates a flow chart of an exemplary supervision process;

FIG. 11 illustrates a flow chart of an exemplary analytical process; and

FIGS. 12A and 12B illustrate a flowchart of an exemplary Dissemination process.

### DETAILED DESCRIPTION

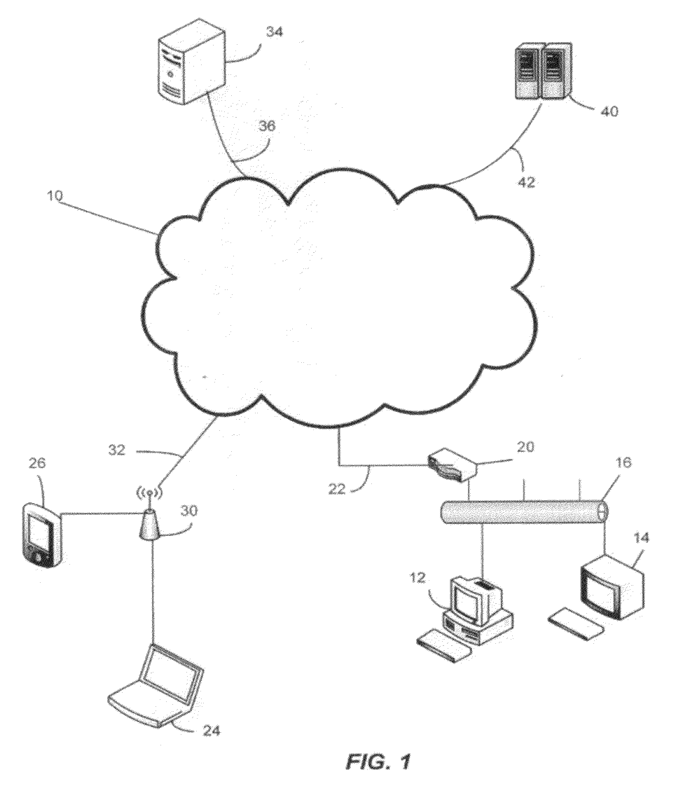

The present disclosure discusses a system designed to provide an integrated intelligence workflow; including data collection forms, supervisory processes, dissemination rules, audit trails, and criminal intelligence legal compliance handling rules for use in a distributed environment. FIG. 1 illustrates an example of a network typical of the World Wide Web. A network 10 may be a virtual private network (VPN), or any other network that allows one or more computers, communication devices, databases, etc., to be communicatively connected to each other. The network 10 may be connected to a PC 12 or a computer terminal 14 by any means able to communicate electronic signals. In one embodiment, the components may be connected to the network 10 via an Ethernet 16 and a router 20, or a land line 22. The network 10 may also be wirelessly connected to a laptop computer 24 and a personal data assistant 26 via a wireless communication station 30 and a wireless link 32. Similarly, a server 34 may be connected to the network 10 using a communication link 36. Also, an information management system 40 may be connected to the network 10 using another communication link 42. Where the network 10 includes the Internet, data communication may take place over the network 10 via an Internet communication protocol. In operation, the client PC 12 may view or request data from any other computing device connected to the network 10. Further, the PC 12 may send data to any other computing device connected to the network 10.

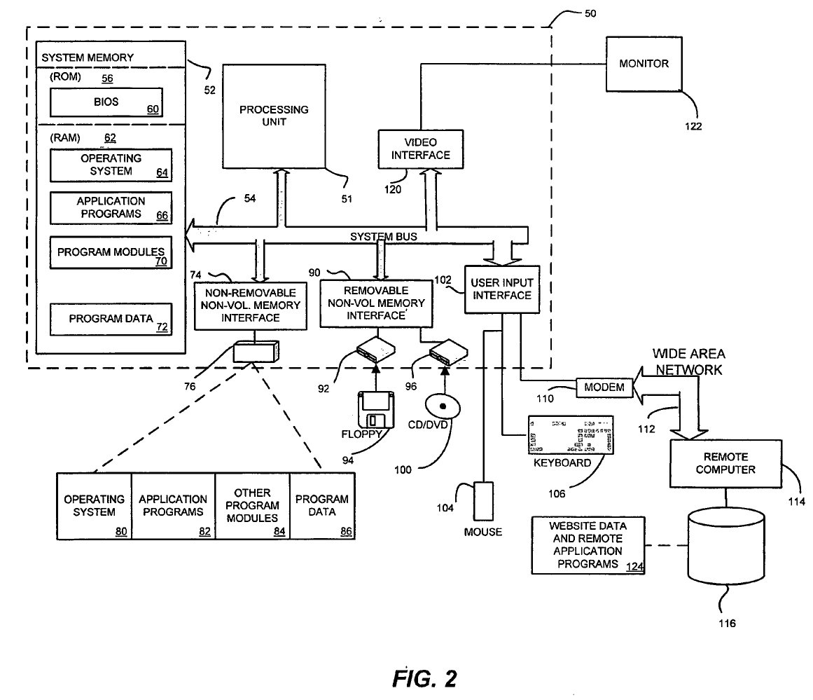

FIG. 2 illustrates a typical computing device 50 that may be connected to the network 10 of FIG. 1 and participate in a distributed computing environment such as the World Wide Web and communicate with an information management system 40. FIG. 2 may also be an example of an appropriate computing system on which the claimed apparatus and claims may be implemented, however, FIG. 2 is only one example of a suitable computing system and is not intended to limit the scope or function of any claim. The claims are operational with many other general or special purpose computing devices such as PCs 12, server computers 34, portable computing devices such as a laptop 24, consumer electronics 26, mainframe computers, or distributed computing environments that include any of the above or similar systems or devices.

With reference to FIG. 2, a system for implementing the steps of the claimed apparatus may include several general computing devices in the form of a computer 50. The computer 50 may include a processing unit, 51, a system memory, 52, and a system bus 54 that couples various system components including the system memory 52 to the processing unit 51. The system bus 54 may include an Industry Standard Architecture (ISA) bus, a Micro Channel Architecture (MCA) bus, Enhanced ISA (EISA) bus, Video Electronics Standards Association (VESA) local bus, a Peripheral Component Interconnect (PCI) bus or a Mezzanine bus, and the Peripheral Component Interconnect Express (PCI-E) bus.

Computer 50 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 50. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media. The system memory 52 may include storage media in the form of volatile and/or non-volatile memory such as ROM 56 and RAM 62. A basic input/output system 60 (BIOS), containing algorithms to transfer information between components within the computer 50, may be stored in ROM 56. Data or program modules that are immediately accessible or are presently in use by the processing unit 51 may be stored in RAM 62. Data normally stored in RAM while the computer 50 is in operation may include an operating system 64, application programs 66, program modules 70, and program data 72.

The system memory 52 may include storage media in the form of volatile and/or non-volatile memory such as ROM 56 and RAM 62. A basic input/output system 60 (BIOS), containing algorithms to transfer information between components within the computer 50, may be stored in ROM 56. Data or program modules that are immediately accessible or are presently in use by the processing unit 51 may be stored in RAM 62. Data normally stored in RAM while the computer 50 is in operation may include an operating system 64, application programs 66, program modules 70, and program data 72.

The computer 50 may also include other storage media such as a hard disk drive 76 that may read from or write to non-removable, non-volatile magnetic media, a magnetic disk drive 251 that reads from or writes to a removable, non-volatile magnetic disk 94, and an optical disk drive 96 that reads from or writes to a removable, nonvolatile optical disk 100. Other storage media that may be used includes magnetic tape cassettes, flash memory cards, digital versatile disks, digital video tape, solid state RAM, and solid state ROM. The hard disk drive 76 may be connected to the system bus 54 through a non-removable memory interface such as interface 74. A magnetic disk drive 92 and optical disk drive 96 may be connected to the system bus 54 by a removable memory interface, such as interface 90.

The disk drives 92, 96 transfer computer-readable instructions, data structures, program modules, and other data for the computer 50 to different storage media 94, 100 for storage. A hard disk drive 76 may store an operating system 64, application programs 66, other program modules 70, and program data 72. These components may be the same or different from operating system 64, application programs 66, other program modules 70 and program data 72. The components associated with the hard disk drive 76 may be different copies than those associated with RAM 62.

The user may interact with the computer 50 through input devices such as a keyboard 106 or a pointing device 104 (i.e., a mouse). A user input interface 102 may be coupled to the system bus 54 to allow the input devices to communicate with the processing unit 51. A display device such as a monitor 122 may also be connected to the system bus 54 via a video interface 120.

The computer 50 may operate in a networked environment using logical connections to one or more remote computers 114. The remote computer 114 may be a PC 12, a server 34, a router 20, or other common network node as illustrated in FIG. 1. The remote computer 114 typically includes many or all of the previously-described elements regarding the computer 50, even though only a memory storage device 116 is illustrated in FIG. 2. Logical connections between the computer 50 and one or more remote computers 114 may include a wide area network (WAN) 112. A typical WAN is the Internet. When used in a WAN, the computer 50 may include a modem 110 or other means for establishing communications over the WAN. The modem 110 may be connected to the system bus 54 via the user input interface 102, or other mechanism. In a networked environment, program modules depicted relative to the computer 50, may be stored in the remote memory storage device 116. By way of example, and not limitation, FIG. 2 illustrates website data and remote application programs 124 as residing on the memory device 116. As may be appreciated, other means of establishing a communications link between the computer 50 and the remote computer 114 may be used.

As previously described, the method and system may allow a justice agency to manage information related to a public crime or a suspicious tip at inception, through the criminal investigation process, and if necessary, into a criminal intelligence management process (i.e., a terrorist investigation.) The method and system may be deployed in only one side, the criminal intelligence side or the criminal side, or both sides simultaneously. The federal government and numerous state statutes maintain separate guidelines on the handling of criminal intelligence records. The systems and methods allow for multiple agencies at the state, local, and federal levels to share either one side or both sides in a distributed environment, while maintaining federal compliance with criminal intelligence record guidelines.

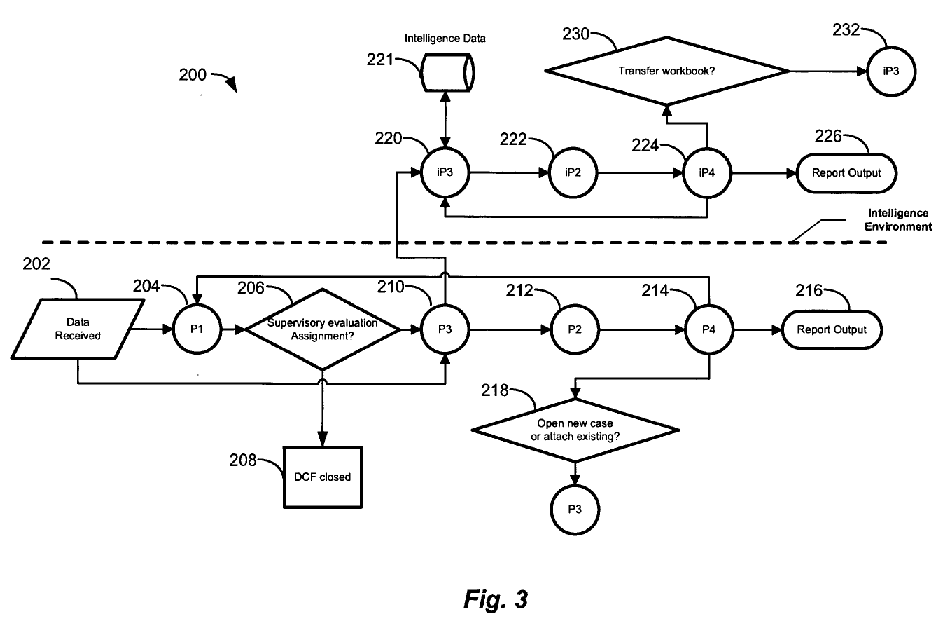

FIG. 3 illustrates a flow diagram of an exemplary modular intelligence-led policing process 200. The disclosed system may be an application-based solution which may be designed around users, roles, and groups, for example. The system may be decentralized for reasons discussed below. In many cases, a user of the disclosed system may have multiple roles. For example, an investigator may also spend part of his or her day working in a criminal intelligence center, or a Major Crimes Division of a Police Department may be involved in both criminal and criminal intelligence investigations.

A robbery, which begins as a crime, may be connected to gang activity, and terrorist attack planning. The flow diagram of FIG. 3 discloses a workflow 200 encompassing the process of working a criminal lead or case, and in parallel, encompasses the processes of working a criminal intelligence lead or case. The two processes are similar in the disclosed system, but the criminal intelligence side may include special handling to comply with Federal guidelines on criminal intelligence files. It is noted that “files” are referred to herein as workbooks. Both terms are used interchangeably throughout this description.

During the course of a criminal investigation, the system may allow the automated transfer of an electronic workbook to the criminal intelligence side. Alternatively, the system may be designed so that the electronic workbook needs to be pushed to the criminal intelligence side. The criminal intelligence side thus inherits not only a copy of the workbook, but also automatically adopts the criminal intelligence guidelines on how to handle the files (workbooks). For example, the system includes a methodology on how to track the age of intelligence files for compliance, and a methodology for sharing these files with other authorized intelligence agencies while maintaining a common legal framework for handling and reviewing all files. The legal rules for how to handle the file, are then part of the file, and are imported by the receiving agency. In addition, the system keeps track of the workbook's audit logs and creates a virtual trail between workbooks which may be resident in different systems. In other words, when an electronic workbook is transferred, a virtual audit trail moves across environments and stays with the workbook, and permits further tracking via the virtual audit trail.

Still referring to FIG. 3, the method 200 begins when data is received in any format (block 202). For example, the data me be received via a tip, a phone call, a fax, an email, etc. The received data may then be entered into the system by an analyst, a technician, or other personnel (block 204). A supervisory evaluation and assignment process may then be performed (block 206). If it is determined at block 206 that nothing further should be done with the received data, then the Data Collection Form may then be closed (block 208). If it is determined at the block 206 that the received data required further analysis, the analytic process begins and an electronic workbook is generated (block 210).

A supervisor may continue to evaluate the received data (block 212) where it may then begin a dissemination process (block 214). Part of this process may include looping back to block 204 for further data collection and analysis. The dissemination process may include generating a report and outputting the report to another criminal case in a static form, such as a PDF (block 216). A user may also determine whether or not a new case should be opened or whether the received data should be attached to an existing workbook (block 218). In either event, further analysis may be performed. It is noted that all of the processes illustrated below the dashed line in FIG. 3 are considered to be in a criminal environment and thus do not need to be purged.

If it is determined at the block 210 that the electronic workbook should be shared with the intelligence environment, the electronic workbook may be transferred for intelligence analysis (block 220). Once transmitted to the intelligence environment, the electronic workbook may be stored in an intelligence database (block 221). The electronic workbook may then undergo supervisory evaluation by an intelligence user (block 222) and possible dissemination (block 224). As with the criminal environment, this may include generating and outputting a report (block 226) and determining whether or not to transfer the workbook (block 230). Further analysis may also be performed (block 232).

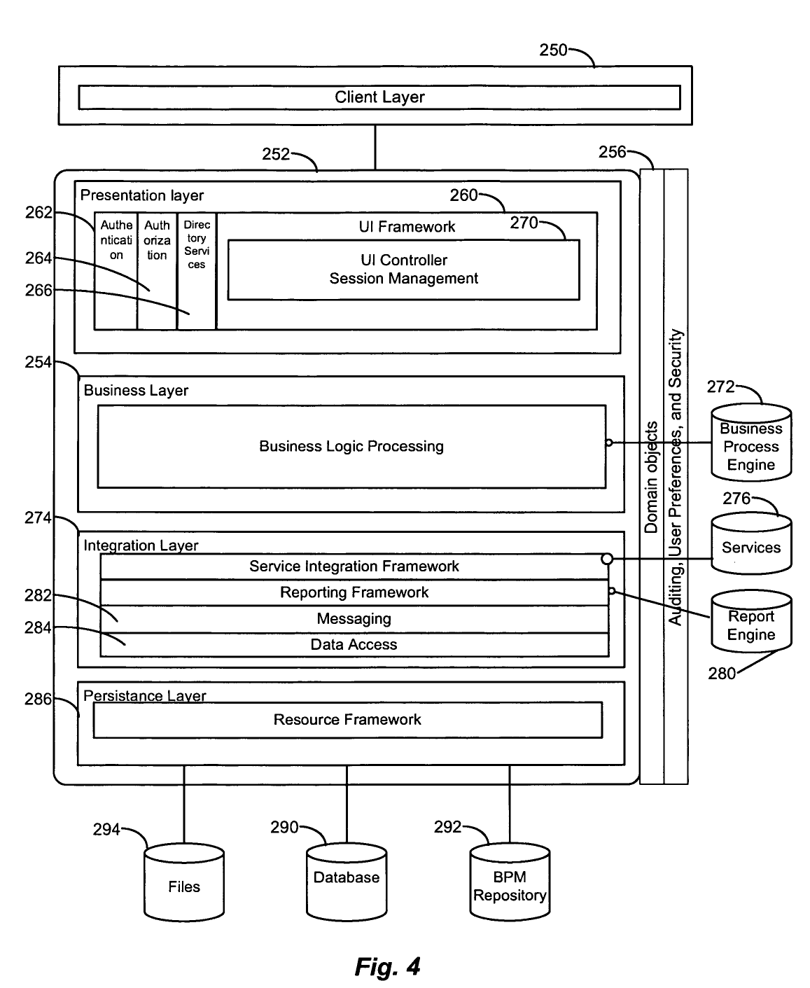

FIG. 4 illustrates an exemplary architectural diagram of the management system. The Client Layer 250 manages interactions with a user. It renders HTML, presents application data, intercepts user input and does rudimentary application-specific range and syntax checking. The Presentation Layer 252 essentially provides the client with the ability to interact with components in the Business Layer 254 such that a number of Business Services may be shared among multiple applications. The Presentation Layer 252 handles exceptions that occur during invocation of the Business Services and also transforms the data in the Domain Objects 256 to other formats required by the different clients in the Client Layer 250. The User Interface and Interactions provided in the Presentation Layer 252 are achieved using a UI framework 260. The UI Framework 260 includes Authentication 262, Authorization 264, Directory services 266, as well as user session management 270.

The Business Layer 254 illustrated in FIG. 4 represents the business logic needed for application. The Business Tier is responsible for implementing Business Services and making them available as service-oriented interfaces to the Presentation Tier 260. The management system connects to the Business Process Engine 272 to define and execute business processes. An Integration Layer 274 provides Technical Services 276 such as, for example, query, transformation, and persistence. The Integration layer 274 contains components involved in integrating the system with external entities. A few examples of external entities are: 1) Technical Services 276 which are used to support the requirements of various business processes; 2) Report Engine 280 which generates various reports based on multiple criteria; 3) Messaging 282 which is used to create, store and exchange electronic data; and 4) Data Access 284 which is used for integration with a resource Layer 286.

The Resource Layer 286 is where the shared enterprise resources such as, for example, database systems 290, BPM repository 292, files 294 and so forth, reside. These resources can be accessed from the Technical Services 276 in an Intermediary Tier. Some examples of Technical Services 276 accessing resources are, for example, the persistence service reading and writing rows to/from the database; a process/workflow service initiating and executing business processes, a file service to read and write files, etc.

Still referring to FIG. 4, Domain Objects are used to transfer data between system components. For example, the Web Services in the Integration Layer 274 mediates the transfer of data from the Persistence Layer to the Business and Presentation Layers 254 and 252. For example, for reading and writing data, the Persistence Service in the Integration Layer 276 interacts with a Domain Object within the Business Layer 254 or Presentation Layer 252 and provides indirect access to the data stored in the backend resource. Changes to the data are then coordinated through the Domain Object and stored in the corresponding repository (database) by a corresponding Technical Service 276.

Authentication 262 and Authorization 264 may span across all layers. Authorization entails applying security policies to regulate which users can access in the system. The management system may be configured to use role-based security. It also supports SSL as well as 3-DES encryption for all transactions. User Authentication as well as all user actions are logged in the system. The system is designed to allow the system administrator to define what the roles are, what they are called, and what permissions these roles are allowed to have within the system. Each role is allowed to conduct certain functions. The system administrator can define and enable mutually exclusive functions and mutually exclusive roles. In addition, each user can enable their own preferences for viewing links, RSS feeds, and Calendar views. As discussed above, all user activities in the system may be captured in an audit trail. Each user may be assigned one of a number of (three, for example) security-level permissions. The user security corresponds to the settings on each workbook, allowing only those with the proper security to be aware of the existence of certain workbooks within the system.

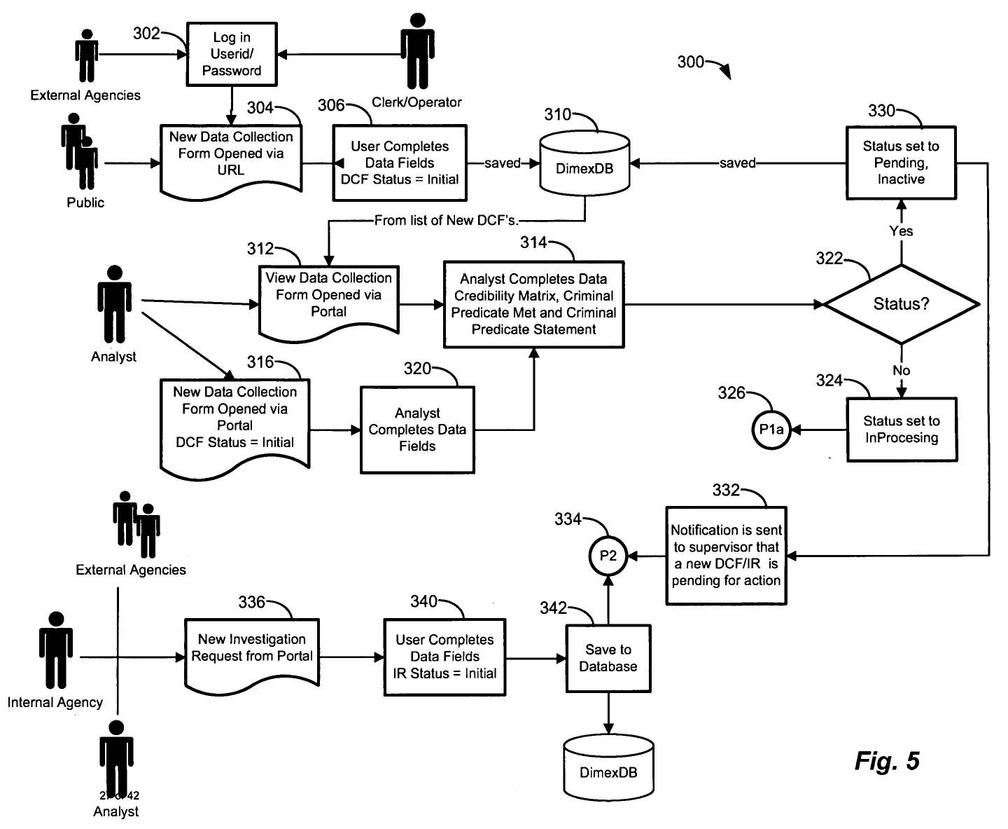

FIG. 5 illustrates a flow diagram of an exemplary Data Collection Process (DCP) 300. The DCP may collect data using a data collection form. The DCP utilizes a user role-based graphical user interface (GUI) that may be presented as an online form with multiple sub-forms presented as tabs on the main form. The Data Collection Process 300 may begin when an external agency or a clerk/operator logs into the system and is authorized after submitting a user ID and password (block 302). The Data Collection Process 300 may include a separate URL for collecting tips and leads from the public (block 304). One of ordinary skill in the art will likely appreciate that this would likely be via a website. There may be multiple types of forms available for input. The user will then complete a number of data fields in a form and set a DCG status to Initial (block 306). Two examples are: Data Capture Form (DCF) and Information/Request for Information (RFI). The form may then be saved in a database (block 310).

An initial DCF form will collect tip/lead information. There may be tabs to enter event/location, suspect, vehicle, organization information as well as submitter information. The data capture form and the Request for Information form, once received by the agency, enter into a workflow process which allows users to track the progress and status of each form. Before entering the workflow, users find all of the DCF forms in a queue. When new DCF forms are entered into the queue, a corresponding time/date stamp is generated.

Still referring to FIG. 5, the data collection method 300 may continue with an analyst viewing a Data Collection Form via a portal (block 312). The analyst may then create a workbook which has the DCF form automatically attached to the workbook (block 314). This may include completing a data credibility matrix, determining if a criminal predicate is met, and generating a criminal predicate statement. Instead of viewing an existing Data Collection Form, the analyst may open a new Data Collection Form via the portal and set the DCF status to initial (block 316). The analyst may then complete the data fields (block 320) and then create the workbook at block 314.

The status of the workbook may then be determined (block 322). If the analyst determines at the block 322 that the workbook requires further processing, the status is set to InProcessing (block 324) and additional data is collected (block 326). If the analyst determines at the block 322 that the workbook does not require further processing, the status is set to Inactive (block 330), the workbook is saved in the database (block 310), and a notification is sent to a supervisor that a new DCF/RFI is pending for action (block 332). The workbook is then in the supervisory evaluation and assignment process (block 334).

If a new investigation request is received from the portal (block 336), the user collects information, completes data fields and sets IR status to initial (block 340). The form is then saved to the database (block 342). A status of a DCF may include: Initial—workflow status of initial; Active—workflow status of Evaluation, Working, Review, Reviewed; Inactive—workflow status of inactive; Pending—workflow status of pending; and Closed—closed.

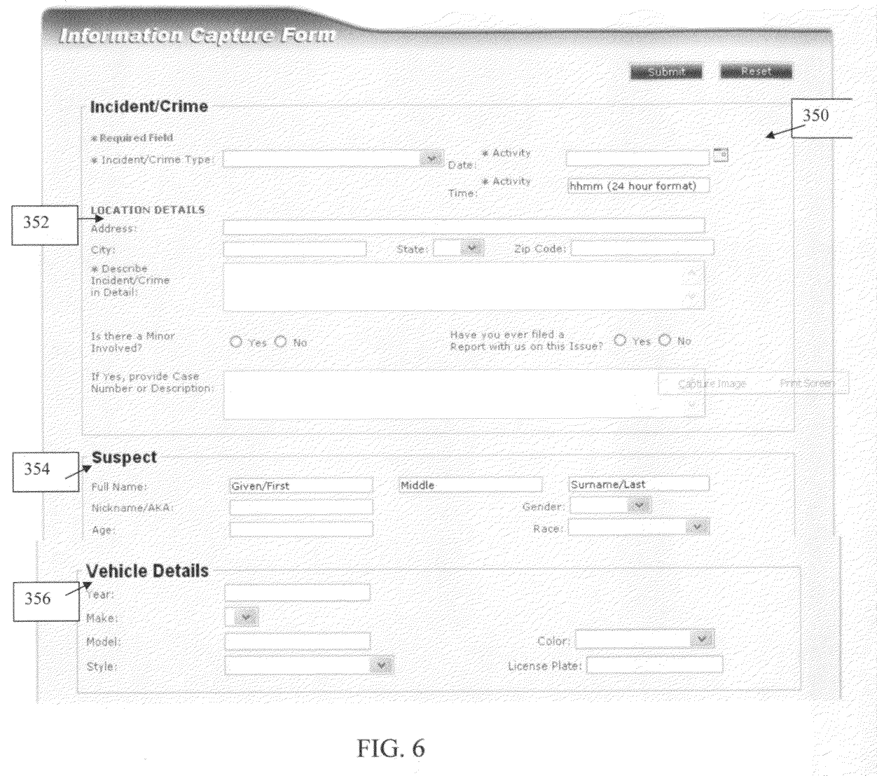

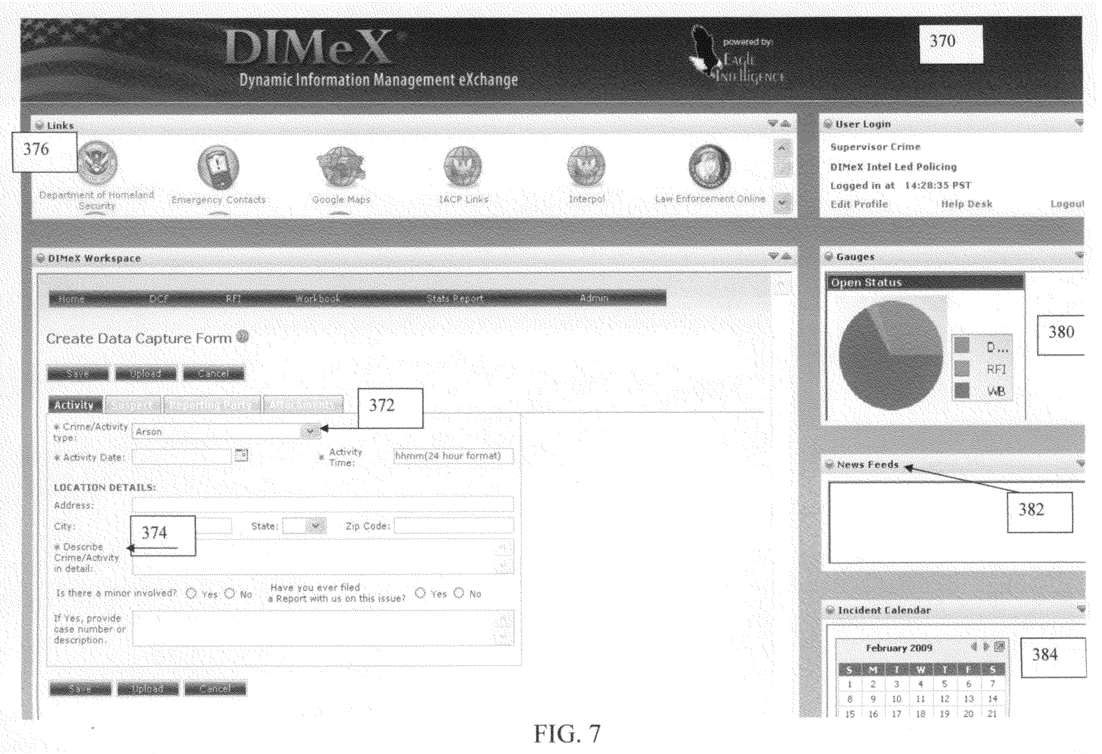

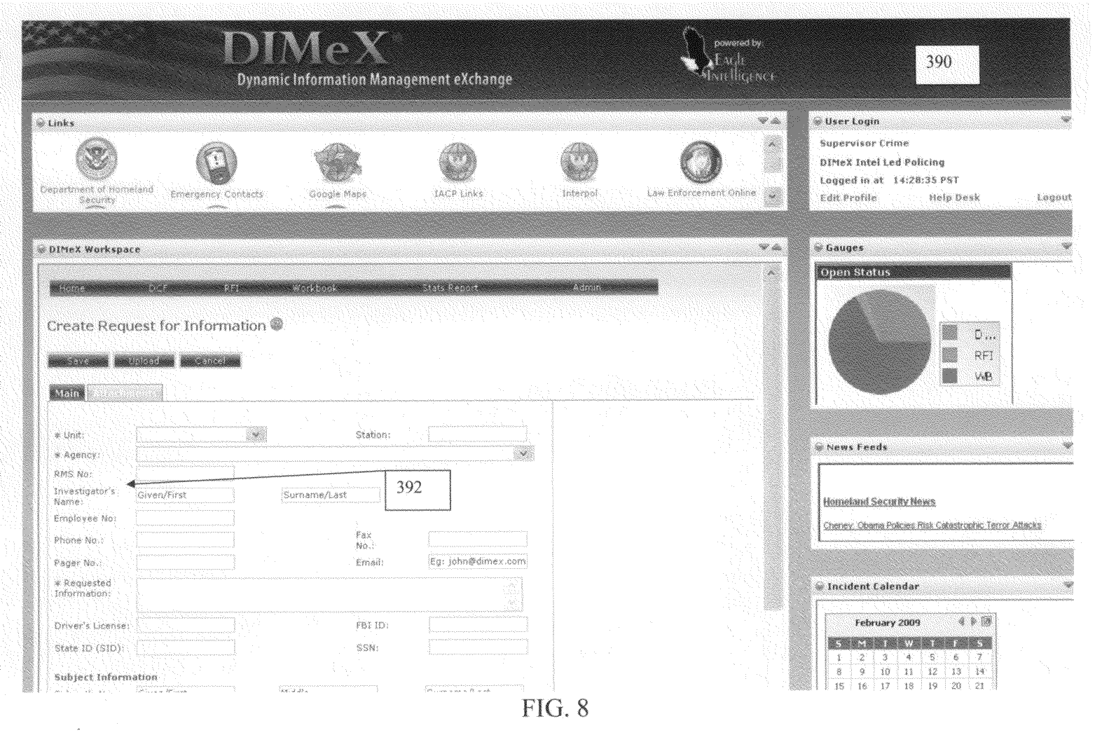

FIG. 6 illustrates a screen shot of an exemplary Public Information Capture Form 350 (Public DCF). This form 350 includes data fields organized into sections to enter data. The sections include an Incident/Crime section 352, a Suspect section 354, and Vehicle Details section 356. FIG. 7 illustrates a screen shot of an exemplary Internal Data Capture Form 370. The Internal Data Capture Form 370 includes sections for entry of crime/activity 372, location details 374, a links section 376, gauges 380, news feeds, 382, and an incident calendar 384. And FIG. 8 illustrates a screen shot of an exemplary Request For Information form 390 which includes a section 392 for entry of information about the agency, investigator, subject, etc.

A Request For Information form may contain information about an agency making request and the requested information. The Workflow Status and Status for the RFI may be the same as the DCF. It is noted that there may be a system configuration option that will either allow notification to be sent to the supervisor role by crime-type or individual supervisor. For supervisor role, a list of supervisors may be specified based on crime-type. If the notification is role-based, then all supervisors in that group may be able to view the incoming RFI's or submitted DCF's. Otherwise, each user is assigned a supervisor (in user properties) and that will be the default supervisor selected. There may be a drop-down with a list of options to allow the user to select another supervisor. A Change of supervisor, change of status and change of crime-type will be entered in the audit log.

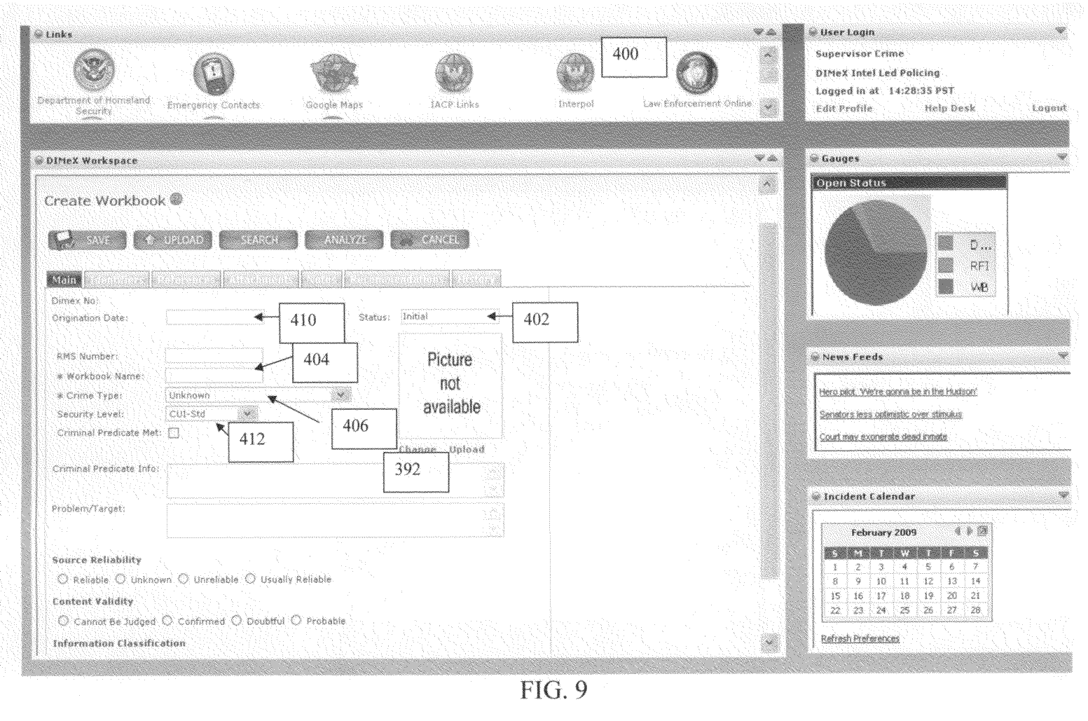

FIG. 9 illustrates a screen shot of an exemplary workbook 400. The workbook 400 is the central place where information is collected and graded. It can contain information such as subjects, organizations, references to other systems, identifiers such as Social Security numbers, lists of the attached documents, and other information pertinent to the agency. In addition, the workbook 400 may contain its status 402, the workbook name 404, crime type 406, and the assigned individual(s). The rules on intelligence file guidelines are wrapped around the workbook and built into the process flow. Because each workbook 400 has an origination date 410, the intelligence workbook 400 also carries with it a destruction date and a workbook review process which gets captured in audit trail, according to federal guidelines on criminal intelligence file handling. An alternative option for the workbook is to set a security level 412. There may be three levels of security on each workbook, such as, for example, Simple, Silent, and Secure. Only users with the appropriate security permissions may be permitted to access a particular workbook.

A new workbook can be created in multiple ways. For example, on approval notification of a DCF/RFI from Supervisor (if approval is required) a new workbook is created. On self-assignment at the end of reviewing a DCF/RFI, a new workbook is created from the DCF/RFI by clicking on a button. After this, the DCF/RFI is automatically attached to the workbook as a reference. Or the User can select a New Workbook button, enter required data fields and attach any documents relevant to the workbook.

Workflow Status for Workbook (wkb) includes Initial—On creation of Workbook; Evaluation—On opening of the wkb before it has been saved. Also, when sent to the intel side, this may be the default status; Working—in processing or analysis phase; Review—submitted to supervisor; Reviewed—supervisor approved/reviewed the record; Inactive—no action to be taken at this time; Pending—waiting on further criteria; and Closed—DCF is closed by supervisor only.

Under a MyWorkbooks tab, users may see a queue of all workbooks that belong to them which have a status of Initial, Evaluation, Working, Reviewed, or Pending. The status of a Workbook may include, for example: Initial—workflow status of initial; Active—workflow status of Evaluation, Working, Review, Reviewed; Inactive—workflow status of inactive; Pending—workflow status of Pending; Closed—closed only by the supervisor.

The information management system may include the ability to upload file(s). The attachments may be displayed with details on file name and date, along with links to open and view them.

It is noted that a workbook can be copied to the Intel side. In this case, electronic copy is made and sent to the Intel system. The status of the workbook is set to Evaluation. The user has the option on the Intel side to open the workbook and create a new Intel Workbook. When the user decides to open a new Intel Workbook, a new Intel system number is generated and the old non-Intel system number is saved as a reference. If the workbook contains references, they are preserved. If it contains links to non-Intel workbooks, then these links will be replaced by links to the corresponding Intel workbooks if an Intel workbook exists.

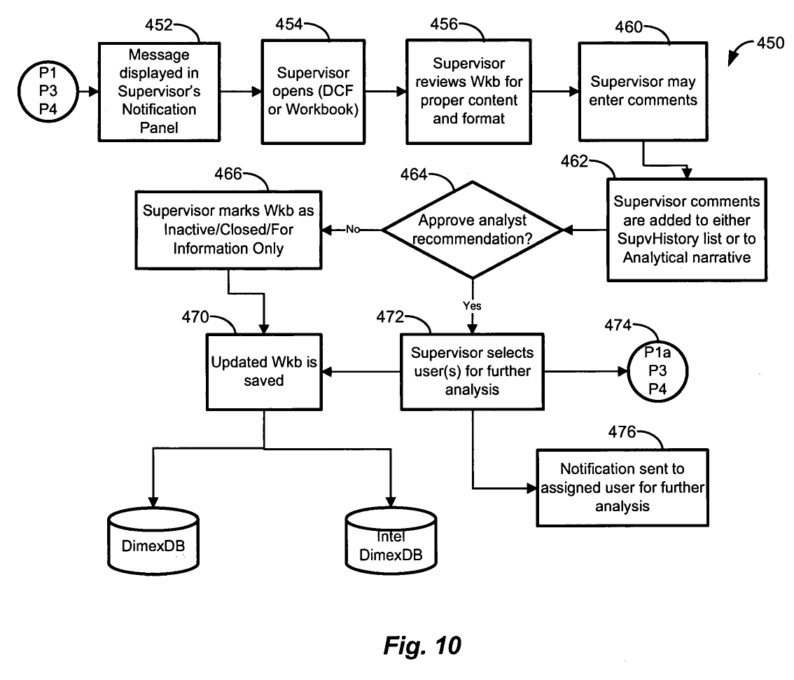

FIG. 10 illustrates a flow chart of an exemplary supervision process 450. A Supervisory Review and Assignment Process 450 may be utilized to ensure user-input data is processed correctly and within standard protocol. The process may also be utilized to assign and delegate additional work tasks to subordinate users. The supervisory user can edit the workbook information as appropriate and input notations which capture the reasons for the changes.

An assignment task group will allow the supervisory user to assign subordinate user to conduct additional analytical work on the information contained in the Workbook. A status task group will give the supervisory user the ability to set a status to the Workbook. This task may be accomplished by a drop down menu of status options (i.e., Active, Inactive, Pending or Closed). A status history of the workbook is logged in a history tab available for users to see. The supervisor may have the option to send a copy of the Workbook to the Intel side.

The supervision method 450 begins when a message is displayed in a supervisor's notification panel (block 452). The supervisor then opens the workbook (block 454) and reviews the workbook for proper content and format (block 456). The supervisor may enter comments in the workbook (block 460) which are added to either a supervisor history list or to an analytical narrative (block 462) and make a decision as to whether or not he or she agrees with the analyst's recommendation (block 464). If the supervisor does not agree with the analyst's recommendation, the supervisor marks the workbook as inactive and closes it (block 466) so that it is saved only for information purposes (block 470). If the supervisor agrees with the analyst's recommendation, the supervisor selects one or more users for further analysis (block 472). Thereafter, the supervisor may keep the workbook open to acquire more data and analysis (block 474) and/or send a notification to assigned user(s) for further analysis (block 476).

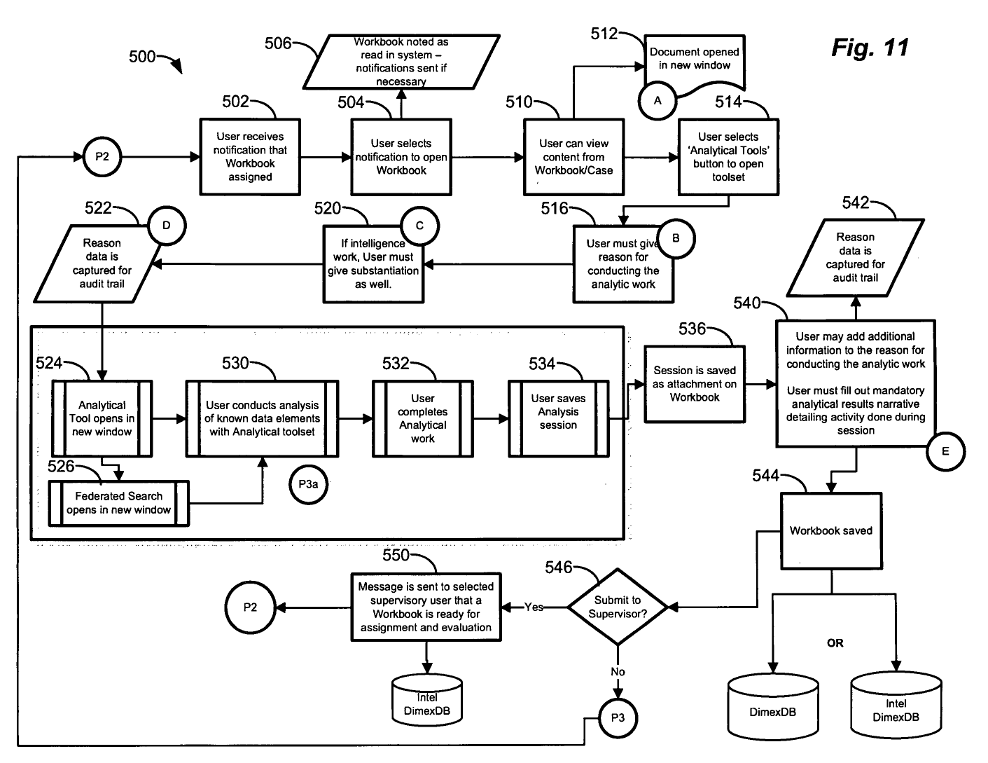

FIG. 11 illustrates a flow chart of an exemplary analytical process 500. In the analytic process 500, an assigned user may conduct analytical work on the information in the Workbook with a set of commercial off-the-shelf analytical tools. When the data analysis is completed, a copy of the analytical session may be saved as an attachment to the Workbook. Multiple sessions may be attached to the workbook

When the workbook is completed and submitted to the supervisor for the first time, a copy of the Workbook can be sent to the Intelligence domain for possible additional work (if an Intelligence side exists). The duplicate copy of the work may appear with a status of “Evaluation” on the Intel side. An Intel User may perform his own analysis and then submit it to the Intel Supervisor. All work that occurs in the intelligence domain may remain in the Intelligence domain and may not be accessible to users in the non-Intel domain. This ensures that all relevant criminal intelligence handling protocols are followed and that intelligence data is secured from accidental dissemination to unauthorized personnel. All work conducted in the intelligence domain as well as audit logs may be stored in a separate Intel Database.

After a supervisor assigns a workbook, the analytic process 500 may send one or more users notification that the workbook was assigned to the user(s) (block 502). The user may select a link to open the workbook (block 504), and the workbook is noted as read in the system (block 506). The user can view the content from the workbook (block 510) and the document can be opened in a new window (block 512) and/or select an analytic tools button to open a toolset (block 514). The user could also select a Federated search. Thereafter, the user may be prompted to input a reason for conducting the analytic work (block 516). If the work is for intelligence work, the process 500 may prompt the user to provided substantiation as well (block 520) which is captured for an audit trail (block 522).

A set of analytic tools may open in a new window (block 524). When appropriate, a Federated search opens in a new window (block 526) and the user can conduct analysis of known data elements with the analytic toolset (block 530). The user then completes at least a portion of the analytical work (block 532) and saves the analysis session (block 534). The blocks 524, 526, 530, 532, and 534 are part of an interchangeable analytical and data exploitation toolset, which may be protected from accidental or intentional purging. The analysis session is saved as an attachment on a workbook with a unique session ID number that is accessible via a workbook references tab (block 536).

Still referring to FIG. 11, the analytic process 500 may continue with the user adding additional information to the reason for conducting the analytic work (block 540). This may include prompting the user to fill out an analytical results narrative detailing activity performed during the session. The reasons for conducting the analytic work is captured for the audit trail (block 542) and the workbook is saved in one of two separate databases, where the databases each comply with different rules. If it is determined that the workbook should be submitted to a supervisor (block 546), a message is sent to selected supervisory user that a workbook is ready for assignment and evaluation (block 550) and possibly saved in an Intel database. Otherwise, the workbook undergoes further analysis and evaluation.

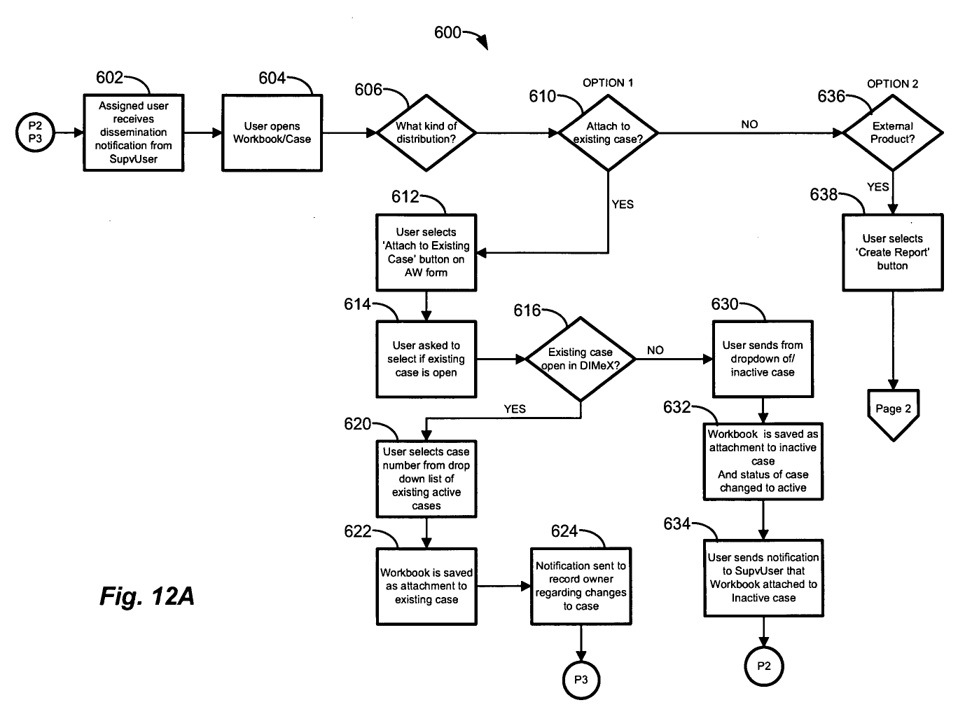

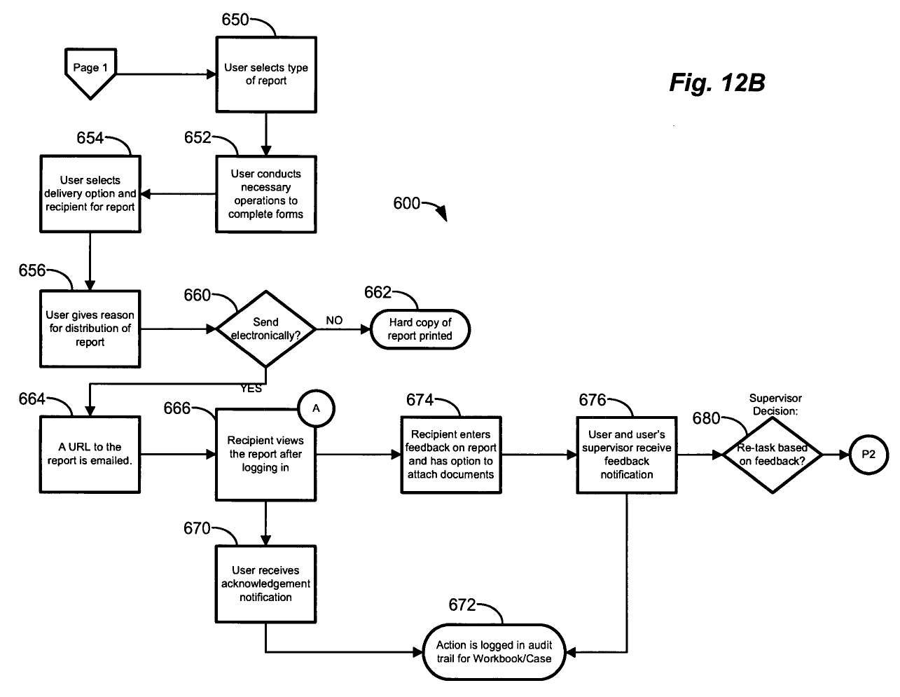

FIGS. 12A and 12B illustrate a flowchart of an exemplary Dissemination process 600. The dissemination process 600 may give the user an opportunity to conduct a choice of two operations on the completed Workbook: (1) produce reports from the system, and (2) attach data to an existing case. The user would request in the analytical narrative that the information be attached to an existing case, but it is the supervisor's responsibility to authorize that it be done.

To produce a report from the system, the user will select which type of report template they wish the Workbook to be extracted into. At least two standard reports may be offered: (1) Criminal Report, and (2) Intelligence Report. The user may then select a delivery option for the report, selecting either a printed output or an electronic copy set to a designated recipient. The user may be required to give a reason for the dissemination by completing a box which contains drop down items and a short narrative text box. The Reason may be stored in the audit log and the narrative may be added to the analytical narrative. The same functionality may be available for case.

For Intel dissemination, a warning message may be displayed to inform the user on whom the report can be disseminated based on the security level of the case/workbook. If the electronic version is chosen, a URL to the eReport may be sent to the user. The eReport is displayed in a read-only mode. The user may be forced to login to the system to view the report.

The other method of dissemination is to provide an electronic copy of the workbook to an outside agency which may be utilizing the same information management system. Rather than a report dissemination, the electronic export and import is accomplished across agencies. The criminal intelligence file guidelines associated with that workbook, follow it between agencies.

The dissemination process 600 may begin when an assigned user receives a dissemination notification from a supervisor (block 602). The user opens the workbook (block 604) and makes a decision about the kind of distribution most appropriate (block 606). If it is determined at a block 610 that the workbook should be attached to an existing case, the user attaches the workbook to an existing case (block 612) and the system prompts the user to input whether or not an existing case is open (block 614). If a corresponding case exists and is found in the database at block 616, the user selects a case number from a drop down menu listing at least a portion of existing active cases (block 620). The workbook may then be saved as an attachment to an existing case (block 622) and a notification is sent to the record owner regarding changes made to the case (block 624).

If it was determined at the block 616 that there was not an existing case open in the database, the user selects from a dropdown menu of inactive cases (block 630) and saves the workbook as an attachment to an inactive case, wherein the status of the case is changed to active (block 632). The user then sends notification to a supervisor that the workbook was attached to an inactive case (block 634).

If the workbook was not attached to an existing case at block 610, an external product may be considered (block 636) and the user may generate a report (block 638). The dissemination process 600 may then continue to FIG. 12B where the user selects a type of report (block 650) and conducts the necessary operations to complete the forms (block 652). The user then selects a delivery option and a recipient for the report (block 654). The user may be prompted to input reasons for distribution of the report (block 656) and determine whether to disseminate the report electronically (block 660). A hard copy of the report may be printed (block 662), or a URL link to the report is emailed to the recipient(s) (block 664).

The recipient views the report after logging into the system (block 666) and the user receives acknowledgement notification (block 670). The actions are also logged in an audit trail for the workbook (block 672). After viewing the report at block 666, the recipient may also enter feedback on the report and be prompted to attach documents (block 674). The user and the user's supervisor then receive a feedback notification (block 676) and the supervisor may decide whether to re-task the workbook based on the feedback (block 680).

One aspect of the information management system is to enable collecting and categorizing of both unscreened (external public) and screened (law enforcement entered) tips and lead information for the justice community. The unscreened and the screened tips and leads information may be entered into a pending review state in the system workflow. Once within the system workflow, it is moved to a closed or inactive state before it is cleared. All activity, including date and time stamps, may be captured in a history file. The information management system captures the initial crime type or suspicious activity report, along with other background information on the incident or subject to aid an analysis or investigation. The information management system also allows for a data collection and analysis process on public and internal tips and leads and other suspicion reports.

Another aspect of the information management system provides for creating a workbook which contains references to other sources of information (tips and leads, Request for Information forms, other workbooks, other 3rd party external system ID numbers, etc.); Identification information (SS#'s, FBI numbers, Driver's License numbers, etc.); Notes entered by authorized users, attachment and upload of external documents. On the criminal intelligence side, the workbook may contain the legal rules on handling criminal intelligence files: workbook grading, review dates, purge dates, a workbook review process, search reasons, dissemination reasons and rules, and a complete history and detailed audit log of all user activity is recorded. The workbook may also contain three levels of security. Individual users with insufficient security permissions may not be allowed to view workbooks set to higher levels of security.

Yet another aspect of the information management system provides for allowing an individual to maintain multiple roles and functions or permissions in the system, and to create mutually exclusive roles and functions. A supervisor may carry greater permissions then a data entry clerk. The information management system allows for the setting of these permissions and grants rights to view and perform defined functions within the system. The information management system also allows mutually exclusive roles and functions to be defined. For example, a compliance officer should not be allowed to create and edit reports, only to view reports and conduct audits in the system.

Another aspect of the information management system is to track workbook sharing across organizations. Each workbook may contain a unique reference number. The history files in each workbook will display where it was disseminated from, and when; or who it was imported from, and when. The legal and security level may remain attached to the electronic workbook. Its history follows it through its life span.

Another aspect of the information management system provides for a built in electronic workflow which allows tracking of leads, investigations and cases from an initial status to a closed or inactive status. Built in workflow provides workflow notifications to users on the system when work is in a queue. For example, a supervisor may receive a request to review a workbook, may make his or her comments, and send it back to the originator for follow-up or closure. The information management system interconnects the data collection, analysis, supervision responsibilities, and dissemination process laterally across the workflow, tracking it to closure.

Another aspect of the information management system provides for generating built in statistical reports which generate internal system counts (tips and leads, Request for Information, number of workbooks, etc.) The report generator extracts information to count items in the workflow process. The information management system may also provide for allowing the dissemination of an Intelligence file to a user not currently on the system. The user may be sent an e-mail which contains a link back to the system. Once the user is authorized, they are able to read the intelligence file, and to leave feedback for the author. The feedback is then contained in the Workbook notes from which the report was originally generated. The information management system may further provide for generating multiple calendars which can be incorporated into one combined view. For example, a terrorist history event calendar, a Muslim calendar, a Christian Calendar, and a Hindu calendar can be combined for a single view, to look for patterns. These calendars can be displayed along with an internal meeting dates calendar if desired.

Although the forgoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

What is claimed is:

1. A method for managing a workflow within and between a criminal case management side and a criminal intelligence management side in a justice and public safety domain comprising:
collecting an unscreened tip, a screened tip, and a lead;
categorizing the unscreened tip, the screened tip, and the lead;
receiving the unscreened tip, the screened tip, and the lead in a pending review state;
capturing a date and time stamp for each of the collected unscreened tip, the screened tip, and the lead;
storing the date and time stamp for each of the collected unscreened tip, the screened tip, and the lead in a history file;
capturing and storing an initial crime type or suspicious activity report;
capturing other background information to aid an analysis or investigation;
entering the collected unscreened tip, the screened tip, the lead, the corresponding date and time stamps, the initial crime type or suspicious activity report and other background information into an electronic workbook; and
transferring the electronic workbook to a second environment, where the second environment has a different set of rules for handling and purging the information in the workbook from a set of rules in an environment where the workbook was created.
